(19) United States
(12) Patent Application Publication
(10) Pub. No.: US 2008/0198006 A1
(43) Pub. Date: Aug. 21, 2008

(54) Security system having intelligent voice responses and voice response method thereof

(75) Inventor: Chin-Wen Chou, Taipei Hsien (TW)

Correspondence Address: Joe McKinney Muncy, PO Box 1364, Fairfax, VA, 22038-1364, US

(73) Assignee: Zippy Technology Corp.

(21) Appl. No.: 11/707,141

(22) Filed: Feb. 16, 2007

(51) Int. Cl. G08B 21/00

(52) U.S. Cl. 340/540

(57) ABSTRACT

A security system having corresponding intelligent voice response and a voice response method thereof aims to output a corresponding intelligent voice response message according to the identification (ID) of visitors. The security system includes a trigger unit to detect action conditions of a visitor and generates a trigger signal, an ID system which has a safe person list, a database containing at least one voice message and an ID unit linking to the database to get the ID information of the visitors and compare with the safe person list to generate an ID signal, and a control unit to get the trigger signal and ID signal, and the voice message from the database to make voice response to the visitor through an output unit.

### FIELD OF THE INVENTION

The present invention relates to a security system and a voice response method and particularly to a security system to output a corresponding intelligent voice response message according to the identification (ID) of visitors and a voice response method thereof.

### BACKGROUND OF THE INVENTION

Conventional security systems can be divided into three types: the first type is a lease burglar-alarm system including security service that has a dedicated data link or phone line connecting to a security control center to alert the security provider when an abnormal signal occurs during a set security period so that security personnel can be dispatched onsite to prevent or contain possible loss or damage caused by burglary or the like; the second type is a purchased burglar-alarm system including security service that has a system design same as the first type but user retains the burglar-alarm system after the service contract with the security provider is expired; the third type is a purchased burglar-alarm system without including security service. Many different types of burglar-alarm systems are now available on the market, such as video monitor CCD and CCTV systems, door guarding with card or sensor badge entry system, alarm detection light and police-civilian link systems and the like. For instance, R.O.C. patent No. M278158 discloses an intelligent door guarding control system which includes an input unit with pushbuttons and signal capturing elements, a signal conversion unit connecting to the input unit to convert a captured signal to a comparison signal for comparing, a comparison unit to compare the comparison signal with a pre-stored signal, an output unit to display the content of the captured signal, and a control unit to control opening and closing of a door lock automatically or manually according to the comparing result of the comparison unit.

These days burglars are more sophisticated and aware of the operation modes of the existing security systems. They often can uncover the response action of an identification unit and security system by doing a number of fake visits and discover the daily activity pattern of a target household. Hence they can sabotage or tamper the security and monitor system while members of the targeted household are absent to invade the house and do pilferage. As the response action of such type of security system will reveal the activity of household members and result in hazards, an improved voice security system has been developed, such as R.O.C patent No. M278991 which is a voice burglar-alarm security system. It includes an intercom body which has a door set and an indoor set, and an answering device located in the indoor set or door set to allow recording of at least two voice messages in advance. When the door bell at the door set is pushed for the first time, a first voice message is answered. When the door bell is pushed for the second time, a second voice message is answered. Thereby it creates an imitating effect of having people in the house to scare off intruders.

However the recorded voice messages of the voice burglar-alarm intercom previously discussed cannot be tailored according to the identification of visitors. It still can be compromised by the wicked and determined people. For instance when the visitor simply knocks the door or shouts loudly to test whether there are people in the house, the voice burglar-alarm intercom cannot respond and the alarm effect cannot be achieved. How to resolve the aforesaid problems is still a big issue in the security business.

### SUMMARY OF THE INVENTION

The primary object of the present invention is to output a corresponding intelligent voice response message according to the identification of visitors.

The security system having corresponding intelligent voice response messages of the invention can output a corresponding intelligent voice response message according to the identification of visitors. It includes a trigger unit to detect action conditions of a visitor to generate a trigger signal, an identification system which has a safe person list and a database containing at least one voice message and an identification unit linking to the database to get the ID information of the visitor and compare with the safe person list to generate an ID signal, and a control unit to get the trigger signal and ID signal and the voice message to perform voice response through an output unit.

To achieve the foregoing object, the invention further provides a voice response method to output a corresponding intelligent voice response message according to the ID of the visitor. The method includes: detecting action conditions of the visitor to generate a trigger signal; getting ID information of the visitor; comparing the ID information with the safe person list to generate an ID signal; and getting the trigger signal and ID signal to output a voice message responding to the visitor through an output unit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of an embodiment of the invention.

FIG. 2 is a flowchart of an embodiment of the invention.

FIG. 3 is a flowchart of another embodiment of the invention.

FIG. 4 is a flowchart of yet another embodiment of the invention.

FIG. 5A is a schematic view of answering response-3 of another embodiment of the invention.

FIG. 5B is a schematic view of answering response-4 of another embodiment of the invention.

FIG. 5C is a schematic view of answering response-5 of another embodiment of the invention.

FIG. 5D is a schematic view of answering response-6 of another embodiment of the invention.

FIG. 5E is a schematic view of answering response-7 of another embodiment of the invention.

FIG. 5F is a schematic view of answering response-8 of another embodiment of the invention.

### DETAILED DESCRIPTION OF THE PREFERRED EMBODIMENTS

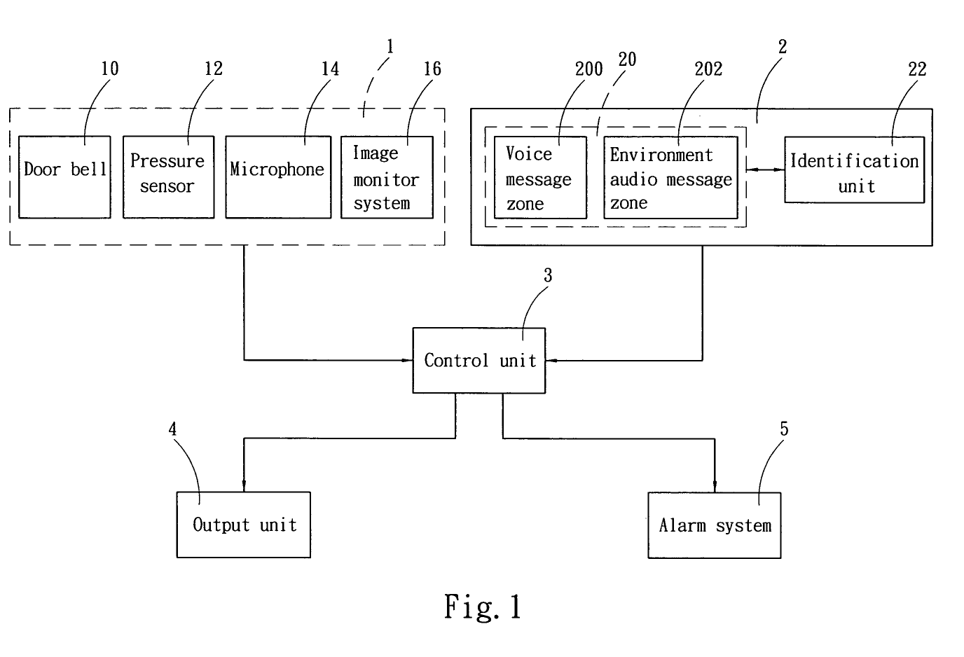

Please refer to FIG. 1 for the structural block diagram of an embodiment of the invention. The security system having intelligent voice response of the invention can output a corresponding intelligent voice response message according to the identification of a visitor. It includes:

a trigger unit 1 to detect action conditions of a visitor to generate a trigger signal. The trigger unit 1 may be a door bell, image monitor system, sensor, microphone or combinations thereof. If the trigger unit 1 is a door bell, the trigger signal is an electronic signal generated after the door bell is triggered. If the trigger unit 1 is a microphone, the trigger signal is an electronic signal generated after the microphone receives the voice of the visitor. If the trigger unit 1 is an image monitor system to get the image information of the visitor, the trigger signal is an electronic signal generated after the image monitor system has determined the content of the image information of the visitor and triggered a preset event (such as the visitor being located in a preset protection zone). If the trigger unit 1 is a sensor (such as pressure sensor or infrared sensor), the trigger signal is an electronic signal generated after the sensor is triggered by detection (such as receiving a pressure or the infrared transmission path is interrupted). In this embodiment the trigger unit 1 includes a door bell 10, a pressure sensor 12 located on a door or window, a microphone 14 and an image monitor system 16;

an identification system 2 which includes a safe person list and a database 20 containing at least one voice message, and an identification unit 22 linking to the database 20 to get ID information of a visitor and compare the ID information with the safe person list to generate an ID signal. The identification unit 22 may be a contact type identification device such as a fingerprint identification device, a palm print identification device, a blood vessel network identification device and a signature identification device, or a non-contact type identification device such as an iris identification device, facial identification device which determines ID by measuring the distance between the bottom of the nose and the upper lip or the angle of the forehead, a voice pattern identification device to determine ID through frequency or voice pitch, a pacing identification device which determines identification through angular alterations of various portions of people's body, an outer ear geometric shape identification device, an odor identification device which determines ID through vapor disseminated from skin pores or the like). The database 20 includes a voice message zone which contains security information and warning information. Beside the voice message zone, the database 20 further has an environment audio message zone, an image message zone, a video message zone or combinations thereof. Furthermore, the database 20 contains environment audio messages, image messages, video messages or combinations thereof. In addition, the database 20 contains multiple sets of voice messages. When the trigger unit 1 receives multiple triggers of a visitor multiple sets of trigger signals are generated. Each trigger signal activates a different voice message according to the trigger sequence. In the event that the multiple sets of voice messages are grouped into a clustered information, the voice messages in each clustered information can be sequenced according to the trigger sequence to activate the voice messages, or the voice messages in each clustered information can be randomly output to randomly activate the voice messages. In this embodiment the identification unit 22 is integrated with the door bell 10 to form a fingerprint identification device. The database 20 includes a voice message zone 200 and an environment audio message zone 202. The voice message zone 200 contains clustered information consisting of multiple sets of voice messages that are sequenced to be activated according to the trigger sequence. The sequence of the voice messages is determined by the intensity of tone and wording in the voice messages. The retrieval sequence of the clustered information may also be set by users according to a selected time period (such as a given day, week or month) such that different clustered information are fetched to prevent the warning information from being generated repeatedly in a given set time period. Such an approach aims to guard against ill-intentioned intruders from getting the same clustered information through multiple attempts in the selected time period; and

a control unit 3 to get the trigger signal and ID signal, and send the obtained voice message from the database 20 to an output unit 4 (such as a speaker, a simplex two-way voice intercom or duplex video intercom) to perform voice response to the visitor. For instance, if the identification system 2 determines that the visitor is one on the safe person list, a security information is retrieved from the database 20 and sent to the speaker to output the security information. This is to warn the ill-intentioned people in the nearby that people are presented the house. If the identification system 2 determines that the visitor is not on the safe person list, a voice message containing the warning information is retrieved and output to the output unit 4 to scare off the intruder. Moreover, after the control unit 3 has obtained the trigger signal, a voice message is sent to the output unit 4 after a period of time. The voice message being sent is different at each time period. In addition, the control unit 3 also is connected to an alarm system 5 (such as an alarm bell, blinking alarm light, communication device or the like). In this embodiment the output unit 4 is a speaker, and the alarm system 5 is a wireless communication device to alert police or a preset contact people.

Moreover, the invention also provides a voice response method adaptable to the security system set forth above. When the security system starts operation, first the trigger unit 1 is activated to monitor whether a visitor presents; if the visitor presents and the trigger unit 1 is triggered and a trigger signal S1 is generated (such as the door bell 10 is pushed, microphone 14 receives voice of the visitor, the pressure sensor 12 detects a push pressure on the door, or the image monitor system 16 captures visitor's image in a preset protection area), the identification unit 22 gets an ID information S2 of the visitor and compares with the safe person list S3 in the database 20 to generate an ID signal.

After comparison, if the ID information of the visitor conforms to the safe person list in the database 20 a security information is retrieved from the voice message zone 200 and a voice message S4 (such as “Welcome home”) in the security information is sent and delivered through the output unit 4. This gives the eligible visitor on the safe person list a genial feeling. This also gives a warning to an ill-intentioned people tailing the visitor that people are presented in the house and any vice attempt should be stopped.

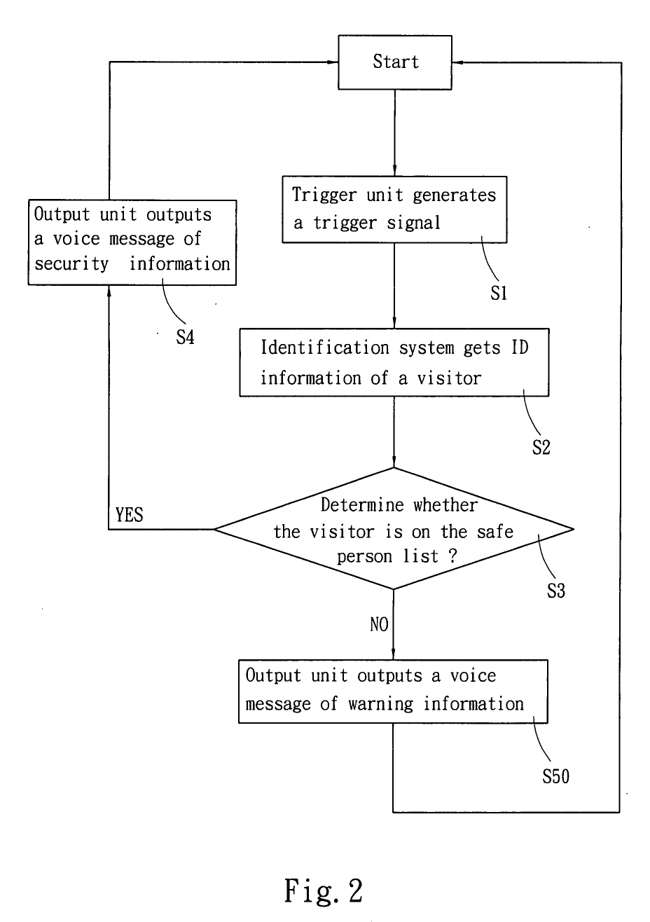

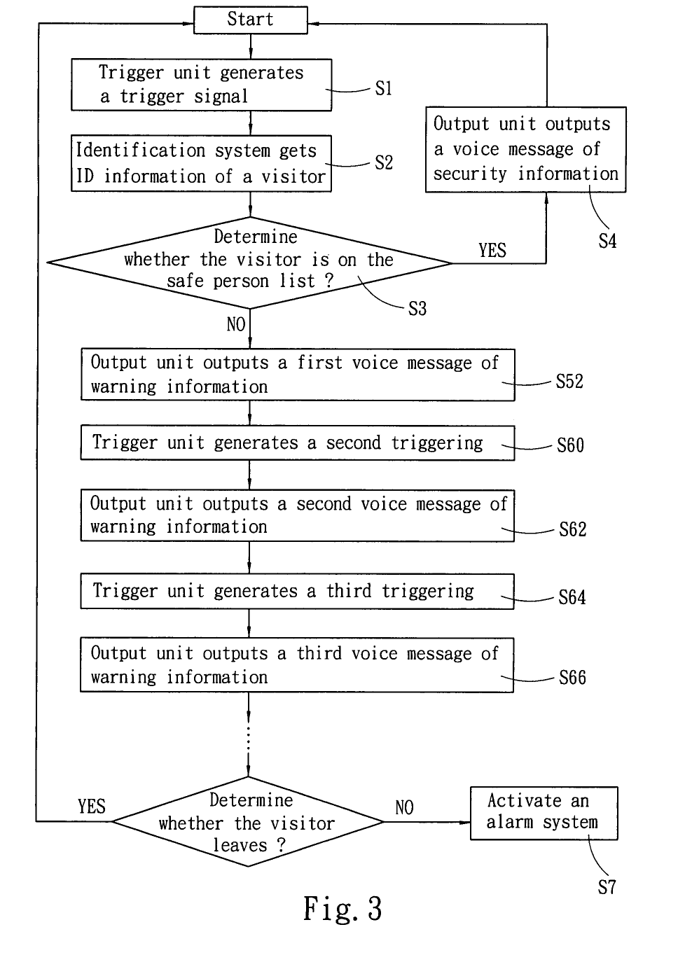

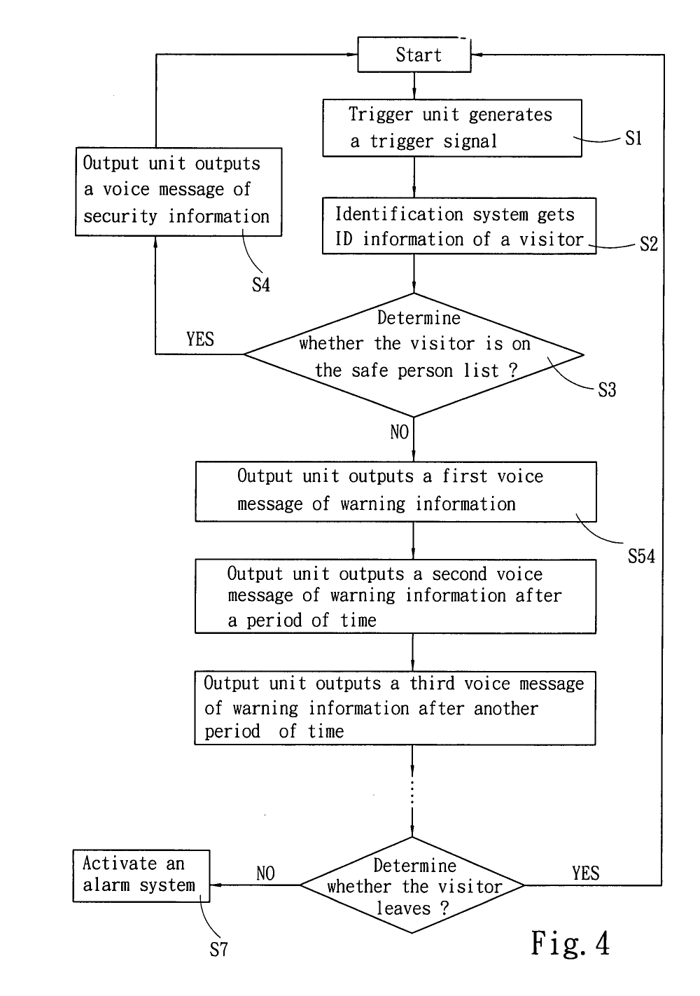

In the event that the comparison result shows that the visitor is not on the safe person list, a warning information in the voice message zone 200 is retrieved from the database 20 and a voice message of the warning information is sent through the output unit 4. FIG. 2 illustrates that the security system returns to an initial condition after a voice message S50 of the warning information is delivered through the output unit 4. FIG. 3 shows that the voice message zone 200 has multiple sets of voice messages. When the trigger unit 1 generates a plurality of trigger signals due to multiple triggers of the visitor, each trigger signal activates a different voice signal S52. The voice signals are sequenced according to the intensity of the tone and wording of the voice messages. Each voice message has a gradually stronger tone according to the trigger sequence, or different voice messages are output randomly. FIG. 4 depicts that after the control unit 3 gets the trigger signal, a voice message is sent to the output unit 4 after a period of time. A different voice message S54 is sent in a different time period.

FIG. 3 also shows that when the visitor not on the safe person list still lingers around after a number of warning voice messages output given by the control unit 3, and a vice attempt likely takes place, the alarm system 5 can be activated to inform the police or a preset security contact people S7 (referring to FIGS. 3 and 4) to prevent the ill intentioned visitor from doing anything harmful.

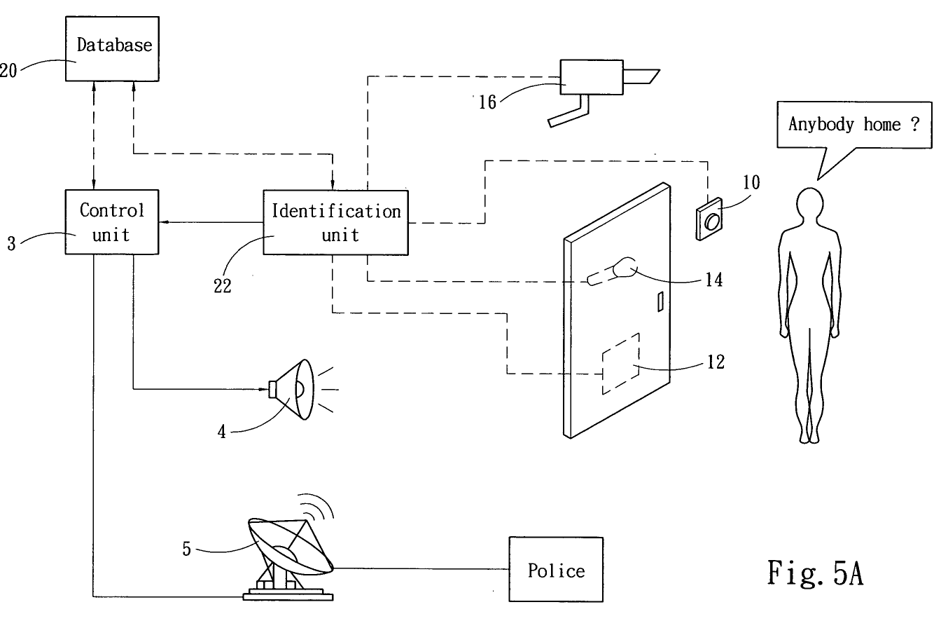

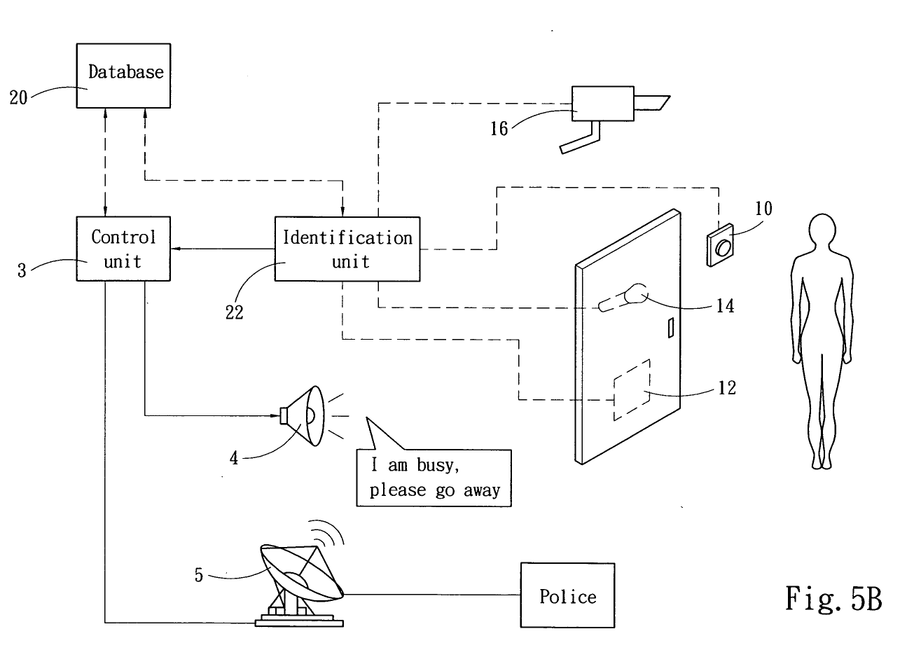

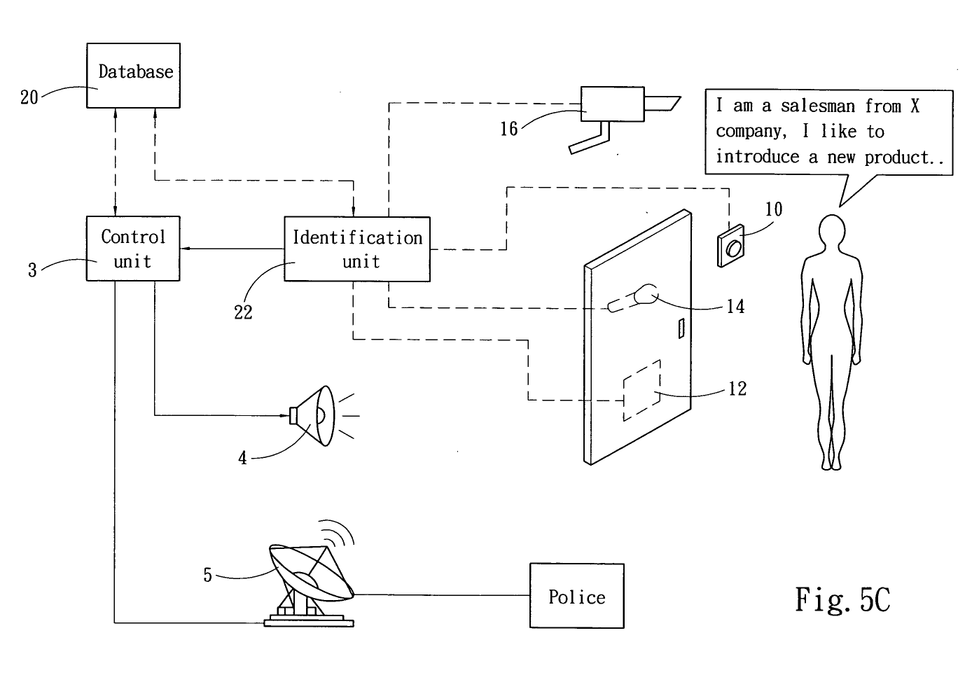

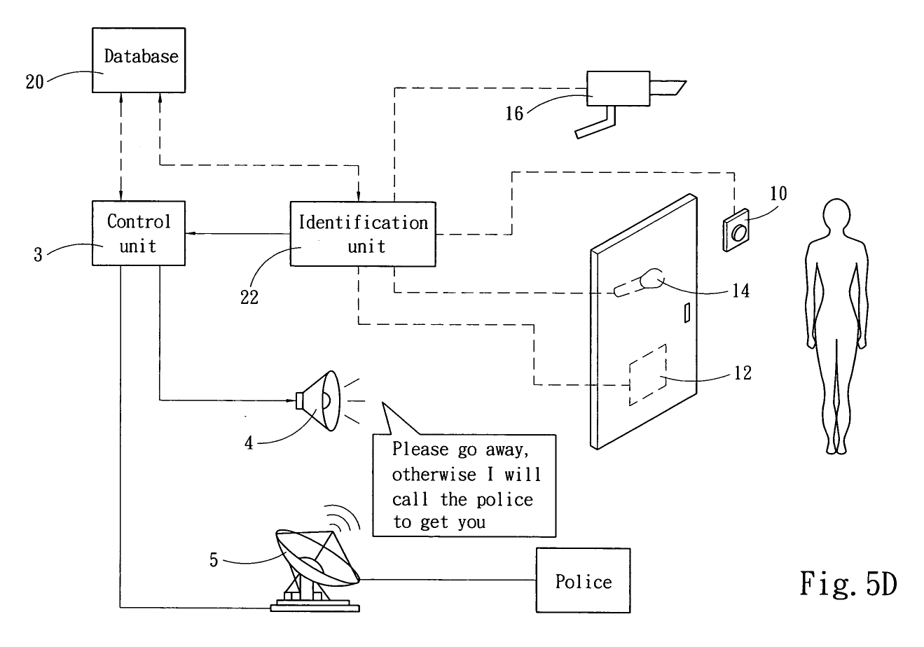

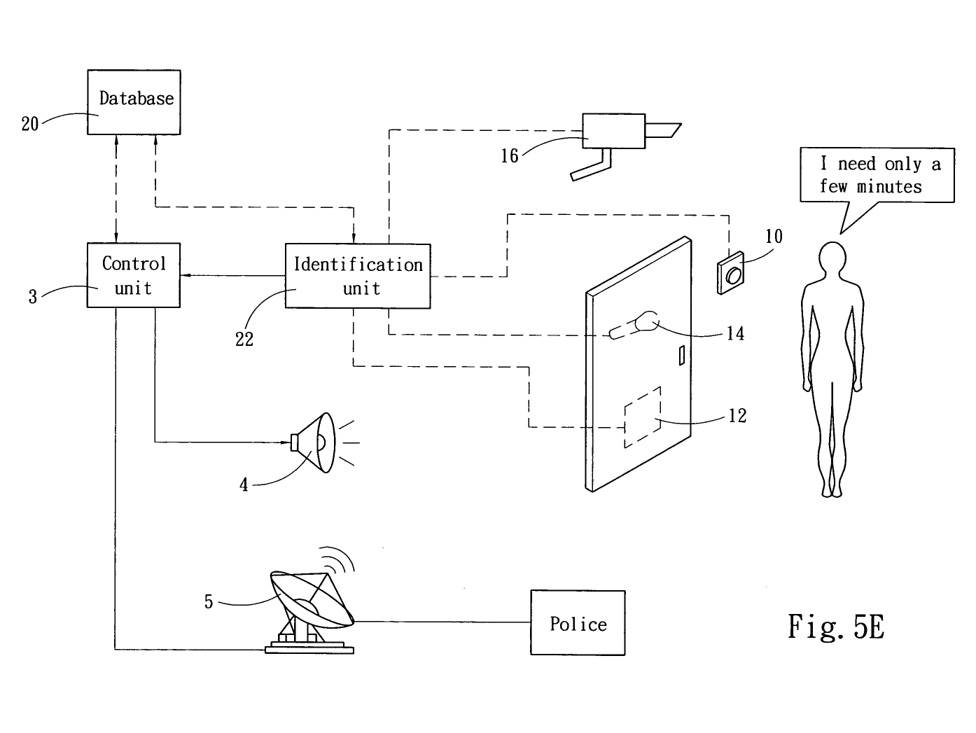

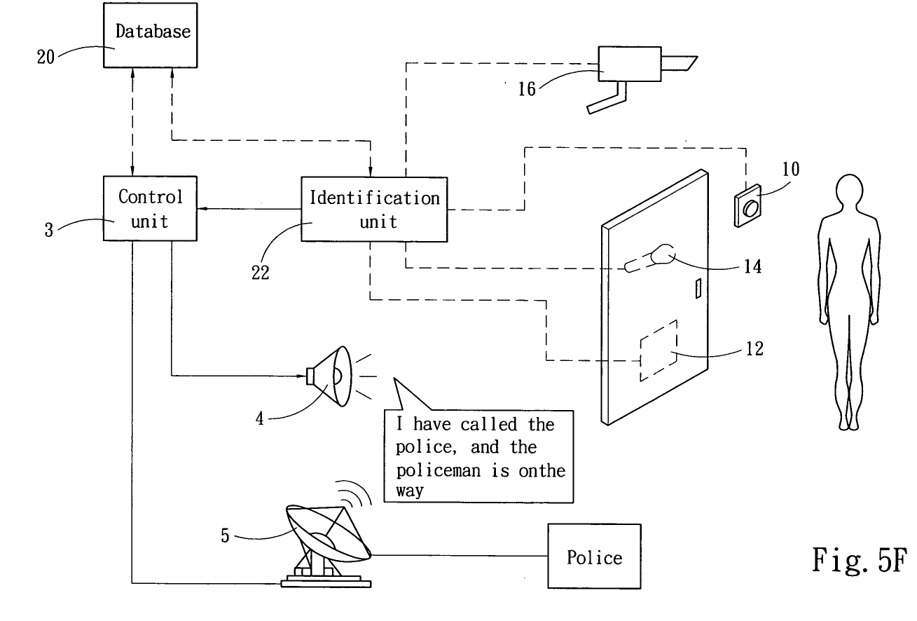

Referring to FIG. 3 again, when the visitor not on the safe person list triggers the trigger unit 1 and generates the trigger signal S1 (also referring to FIG. 5A), the output unit 4 outputs a first voice message of the warning information (in this embodiment, referring to FIG. 5B, the first voice message is “I am busy, please go away.”). This aims to alert the visitor that people are presented in the house so that he/she has better back off. If the visitor does not leave and triggers the trigger unit 1 to generate a second trigger signal S62 (referring to FIG. 5C), the output unit 4 outputs a second voice message of the warning information (in this embodiment, referring to FIG. 5D, “Please go away, otherwise I will call the police to get you.”). In the event that the visitor still lingers and triggers the trigger unit 1 to generate a third trigger signal S64 (referring to FIG. 5E), the output unit 4 outputs a third voice message of the warning information (in this embodiment, referring to FIG. 5F, “I have called the police, and the policeman is on the way.”). Finally, after the control unit 3 has output a number of voice messages from the warning information, and the visitor not on the safe person list still try to pry or molest, the alarm system 5 is activated to inform the police to foil the vice attempt of the visitor.

The invention, aside from outputting the security information and warning information in the voice message zone 200 of the database 20, may also deliver security information and warning information in the environment audio message zone 202 of the database 20 to scare off the ill intentioned people (such as talking of many people, barking of dogs, and the like).

Furthermore, the output unit 4 may be a two-way video intercom. The database 20 has a video message zone (not shown in the drawings) which contains video formats of security and warning information. In the event that people are in the house and there is no need to activate the intelligent voice response security system of the invention, by means of the two-way video intercom the people in the house can communicate with people outdoors through images and voice. In the event that there is no people in the house and the intelligent voice response security system is activated, the two-way video intercom can retrieve the security and warning information stored in the video message zone (such as people's image message and voice message) and send out through the two-way video intercom to give the visitor outdoors an impression that people are presented in the house.

In short, through the identification system 2 of the invention the ID of visitors can be determined. To people not on the safe person list, same or different voice messages of warning information can be retrieved and delivered sequentially according to their actions to foil their vice attempt. Such a design overcomes the drawback of the conventional voice burglar-alarm intercom that cannot respond according to the ID of the visitors. In the event that the visitors knock the door or shout, a corresponding response is provided to scare off the ill intentioned visitors. Thus it provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A security system having intelligent voice responses to output a corresponding intelligent voice response message according to the identification of a visitor, comprising:
a trigger unit to detect action conditions of the visitor and generate a trigger signal;
an identification system which includes a safe person list and a database containing at least one voice message and an identification unit linking to the database to get identification information of the visitor and compare the identification information with the safe person list to generate an identification signal; and
a control unit to get the trigger signal and the identification signal and link to the database to get the voice message to perform voice response to the visitor through an output unit.

2. The security system of claim 1, wherein the trigger unit is selected from the group consisting of a door bell, an image monitor system, a sensor, a microphone and combinations thereof.

3. The security system of claim 1, wherein the database includes either a voice message zone, an environment audio message zone, an image message zone, a video message zone and combinations thereof.

4. The security system of claim 3, wherein the output unit is a two-way video intercom.

5. The security system of claim 1, wherein the database has multiple sets of voice messages, the trigger unit receiving multiple triggers of the visitor to generate multiple sets of trigger signals.

6. The security system of claim 5, wherein each of the trigger signals activates a different voice message according to triggering sequence.

7. The security system of claim 5, wherein the multiple sets of voice messages are grouped into a clustered information, each clustered information containing the voice messages which are sequenced.

8. The security system of claim 5, wherein the multiple sets of the voice message are grouped into a clustered information, each clustered information containing the voice messages which are randomly output.

9. The security system of claim 1, wherein the control unit gets the trigger signal and outputs different voice messages to the output unit periodically.

10. The security system of claim 3, wherein the voice message zone of the database is divided into security information and warning information.

11. The security system of claim 1, wherein the control unit is connected to an alarm system.

12. A voice response method to output a corresponding intelligent voice response message according to the identification of a visitor, comprising the following steps:
detecting action conditions of the visitor to generate a trigger signal;
getting an identification formation of the visitor;
comparing the identification information with a safe person list to generate an identification signal; and
getting the trigger signal and the identification signal and delivering a voice message to the visitor through an output unit.

13. The voice response method of claim 12, wherein the step of delivering a voice message is followed by informing a preset contact person through an alarm system.

14. The voice response method of claim 12, wherein the step of delivering a voice message is coupled with delivering either an environment audio message, an image message or a combination thereof.

15. The voice response method of claim 12, wherein the voice message is stored in a database which has multiple sets of voice messages to generate multiple sets of trigger signals upon receiving multiple triggers of the visitor.

16. The voice response method of claim 15, wherein the multiple sets of voice messages are grouped into a clustered information each containing the voice messages to be output randomly through the output unit.

17. The voice response method of claim 15, wherein the multiple sets of voice messages are grouped into a clustered information each containing different voice messages to be output periodically through the output unit.

18. The voice response method of claim 15, wherein the multiple sets of voice messages are grouped into a clustered information each containing sequenced voice messages to be output sequentially through the output unit.

19. The voice response method of claim 15, wherein each of the trigger signals activates a different voice message according to triggering sequence.
